(19) United States
(12) Patent Application Publication
(10) Pub. No.: US 2004/0076197 A1
(43) Pub. Date: Apr. 22, 2004

(54) Fibre laser

(76) Inventors: William A. Clarkson, Southampton (GB); Duncan W.J. Harwood, Santa Clara, CA (US); Paul W. Turner, Eastleigh (GB)

Correspondence Address: Don W Bulson, Renner Otto Boisselle & Sklar, 19th Floor, 1621 Euclid Avenue, Cleveland, OH, 44115, US

(21) Appl. No.: 10/450,865

(22) PCT Filed: Dec. 18, 2001
(86) PCT No.: PCT/GB01/05626

(30) Foreign Application Priority Data
Dec. 21, 2000 (GB) 0031463.3

(51) Int. Cl. H01S 3/30

(52) U.S. Cl. 372/6

(57) ABSTRACT

A Fibre-based optical source comprises a high power laser diode stack as a pump source, the output of which is shaped into an intense beam of elongate cross-section by use of focusing and light concentrating elements. The beam is used to cladding pump a fibre having an inner cladding also with elongate cross-section, to provide high efficiency pumping. To achieve high output powers with a good mode quality, an overall large core ara is provided by configuring the fibre to have a plurality of individual cores doped with active ions and arranged within the inner cladding in a linear array. Each individual core is configured for single mode operation, so that a plurality of single mode lasers outputs are generated, which can be combined to produce one single mode high power output. The source may also be configured as a laser or as an amplifier.

### BACKGROUND OF THE INVENTION

This invention relates to lasers, and more particularly to a technique for increasing the power in a laser beam.

There are many applications of lasers where a high average power laser beam with good beam quality is required. Such applications include; welding, drilling, precision machining, marking, cutting, materials processing, as well as applications in medicine and defence. There are many different approaches for producing high power laser beams including, for example, carbon dioxide lasers operating at wavelengths around 10 μm, and arc-lamp pumped or diode laser pumped solid state crystal lasers (e.g. Nd:YAG) operating at shorter wavelengths around 1 μm. In both cases, lasers with output powers in excess of 1 kW have been demonstrated [e.g. 1]. Carbon dioxide lasers have the disadvantage compared to solid state lasers of a much longer operating wavelength. Thus, when focussed tightly, a short wavelength solid state laser can produce much higher laser intensity than a carbon dioxide laser with the same output power. Unfortunately, high power solid state lasers suffer from the problem that the heat generated in the laser medium, due to the laser pumping cycle, results in strong thermal effects [2] which can degrade laser efficiency and beam quality, and can even result in laser failure due to stress induced fracture of the laser rod. Numerous schemes to alleviate some of the problems associated with heat generation in the laser medium have been reported (e.g.[1]), but a satisfactory solution for solid state lasers operating at the kilowatt power level and beyond has yet to established. The net result is that high average power solid state lasers frequently suffer from poor beam quality with M² beam propagation factors >>1 (often M²˜10 to 100 for kilowatt class lasers) and low efficiency compared to lasers which operate at lower powers. This has limited their applicability, particularly in areas which require a combination of high power and good beam quality (i.e. high brightness).

Double clad fibre lasers, cladding pumped by high power diode lasers, offer an alternative means for scaling laser power whilst maintaining good beam quality and high efficiency (e.g. [3,4]. In this laser configuration the heat generated due to the laser pumping cycle can be distributed over a long length of fibre reducing the likelihood of damage. Furthermore, the output beam quality is now determined by the waveguiding properties of the active laser ion doped core, which can be tailored to select a single spatial mode output beam. In contrast to conventional ‘bulk’ laser crystals, thermal lensing generally has little impact on beam quality in fibre lasers. Thus, cladding pumped fibre lasers are largely immune to the thermally induced problems which are so detrimental to the performance of conventional ‘bulk’ solid state lasers. In spite of these attractions, conventional cladding pumped fibre lasers have only limited power scalability due a combination of the difficulty in in-coupling higher pump powers from multiple diode lasers, and the limited scope for scaling the core area to avoid laser intensity induced damage whilst maintaining single spatial mode beam quality. The maximum output power reported so far for a cladding pumped fibre laser is 110 W [4].

A key requirement for further power scaling is the ability to increase the core area to avoid detrimental nonlinear effects and damage due to the high intracavity laser intensity. One way to achieve this, reported by Cook et al. [5], is to use multiple fibre lasers, each with a single core, and combine their beams into a single laser beam in a common section of the laser cavity, which comprises a collimating lens, a diffraction grating and a partially transmitting mirror, the latter serving as the output coupler. The individual fibres are arranged so that their ends (opposite to the pump in-coupling end) are positioned in close proximity in a linear array with the collimating lens and diffraction grating positioned at respective distances roughly equal to a focal length and twice the focal length of the collimating lens from the fibre end faces. Thus, the action of the diffraction grating is to automatically select the wavelength of each fibre laser so that they are combined into a single beam at t he diffraction grating. If the fibre cores are chosen to ensure single mode operation of each fibre laser, then the resulting spectrally combined beam is also single mode. Thus, this approach for power scaling exploits the broad gain linewidths that are typical in glass hosts to allow the effective core area (i.e. the combined core area) to be increased without degrading beam quality. A similar approach to beam combining has been used to combine the outputs of the elements in a broad stripe linear diode laser array [6].

This approach for power scaling does however have a number of major drawbacks. Firstly, each fibre must be pumped by one or more laser diode arrays with appropriate in-coupling optics. The maximum pump power available from commercially available diode laser bars is currently in the range 40 to 60 W (depending on the laser configuration and manufacturer) limiting the maximum output power per fibre to around 40 W or less. Thus, scaling the combined power to very high power levels would require many diode pumped fibres, each with its own diode laser pump source and set of pump in-coupling optics. For example, a combined power of over one kilowatt would require in excess of 25 diode pumped fibres. The net result would be an extremely complicated and expensive laser system, limiting its applicability. A further disadvantage of this approach is that the minimum separation of the cores in adjacent fibres could be no less than the diameter (or outer dimension) of the fibre's inner cladding. The latter would normally be chosen to ensure efficient in-coupling of the diode pump laser, and hence would depend on the type of diode laser used and on the design of the in-coupling optics. For the present generation of high power diode bar pump sources and optimally designed pump beam conditioning and focussing optics, the inner cladding size required would be typically >200 μm, which is much greater than a typical single mode core diameter. This sets a upper limit on the number of fibre lasers that can be combined in this way, and hence the combined single mode power, since the core-to-core separation is approximately proportional to the separation of the operating wavelengths of adjacent fibres, and the laser medium has only a finite gain bandwidth. A further drawback of this approach is that each fibre needs a separate high reflector (e.g. a dielectric mirror or in-fibre Bragg grating) located at the pump in-coupling end of the fibre, which must have high transmission at the pump wavelength and high reflectivity at the lasing wavelengths to provide feedback for efficient laser operation. In a high power laser system this would lead to a requirement for many mirrors, adding complexity and extra cost to the laser. A further disadvantage of this prior art approach is that each of the fibres in the array must be independently and accurately aligned, so that each fibre end face lies in the focal plane of the collimating lens, and so that the core positions lie on a straight line with any deviation in core position being much smaller than core diameter. These alignment conditions are required to ensure good beam quality for the combined output beam, but add significant extra complexity in the alignment procedure, which may be costly to achieve. The combination of these features render this technique for power scaling, described in the prior art, of limited practical value.

A further fibre-based approach to achieving high powers is disclosed in EP-A-1 059 707 [7]. A fibre laser includes a number of parallel waveguides arranged within a ribbon fibre. To achieve single mode operation, each waveguide has a core which is narrow in one dimension, to suppress high order modes, but wider in the orthogonal dimension to give a larger core area and hence increased power. High order modes in this dimension are removed by use of mode filters and absorbers built into the fibre. The fibre is side-pumped with laser diode bars, arranged along the length of the fibre so that pump light from one bar can be fully absorbed before light from the next bar is introduced. Several bars are required to scale the power adequately, which may lead to impractically long fibre lengths. Also, the side-pumping arrangement requires transmission gratings within the fibre to direct the pump light along the fibre. Overall, the structure of the ribbon fibre is complex, leading to high fabrication costs.

### SUMMARY OF THE INVENTION

The approach for power scaling according to this invention uses a novel laser design to overcome the limitations of the prior art, allowing practical, efficient and relatively low cost power scaling of a fibre laser to very high average power levels, whilst maintaining good laser beam quality, thus serving the requirements of numerous applications.

A first aspect of the present invention is directed to a source of optical radiation comprising:

a laser diode stack comprising one or more laser diode bars and operable to emit pump radiation;

beam shaping optics operable to focus the pump radiation into a beam with elongate cross-section;

an optical fibre having an inner cladding of elongate cross-section and arranged so that the beam of pump light is coupled into at least one of its ends; and

one or more optical fibre cores doped with active ions and having an overall elongate cross-section arranged parallel to the elongate cross-section of the inner cladding, and arranged to absorb the pump radiation via the inner cladding so as to generate and emit output radiation by stimulated emission.

Such a system exploits the high powers available from laser diode stacks to pump an fibre-based optical source. The output of laser diode stacks typically has a relatively poor beam quality, but this issue is addressed in the present invention by shaping the output into a high intensity beam of elongate shape. This gives a beam of higher intensity than if a more conventional circular beam is attempted, intensity being important with regard to achieving efficient pumping. To derive maximum benefit from the elongated beam profile, the beam is used to cladding-pump a fibre of elongate cross-section, a combination which not only offers efficient coupling of the pump into the fibre, but also readily allows the use of various configurations of one or more cores.

The stimulated emission may produce laser action, if the optical fibre core or cores are arranged within an optical cavity operable to provide optical feedback of the output radiation. Alternatively, the stimulated emission may produce optical amplification, if the optical fibre core or cores are arranged to receive signal radiation to be amplified by gain arising from absorption of the pump radiation. Thus the invention is applicable to both lasing and amplification, and can hence be exploited in a wide variety of applications.

The one or more optical fibre cores may be positioned within the inner cladding of the optical fibre. This arrangement means that only a single fibre is needed, so that the source is relatively simple. Furthermore, the source may further comprise one or more additional optical fibres arranged side-by-side with the first-mentioned optical fibre such that pump light is additionally coupled into inner cladding of the additional fibre or fibres. This allows the system to be scaled up in the event that there are limitations on the size of fibre which can be fabricated, as the fibres are placed adjacently to form, in effect, one larger fibre.

Alternatively, the one or more optical fibre cores may be positioned within an inner cladding of a second optical fibre arranged in optical communication with the inner cladding of the first-mentioned optical fibre. The separation of the doped cores from the pump-receiving fibre offers more flexibility in system design, and may therefore be more suitable in certain circumstances. For example, this configuration is well-suited for use an amplifier, because the core or cores are contained in a fibre having free ends, into which the optical signal to be amplified may readily be coupled, distinct from the coupling of the pump radiation into the first-mentioned fibre. Also, the source may further comprise one or more additional laser diode stacks with associated beam shaping optics and optical fibres, each optical fibre having an inner cladding arranged in optical communication with the inner cladding of the second optical fibre. Thus, the pump radiation from a number of laser diode stacks can be conveniently coupled into a single core-containing fibre, thus allowing the available pump power to be increased.

The one or more optical fibre cores may comprise a plurality of cores arranged in a linear array. Multiple cores offer a good solution to the problem of power scaling, as they offer an overall large core area without the problems of multimode beams inherent in single large area cores. Also, there are thermal problems such as thermal lensing associated with the use of single large area cores which are to a large extent overcome by using multiple smaller cores.

The plurality of cores may be substantially equally spaced along the linear array, or alternatively may be unequally spaced along the linear array. These configurations offer scope for tailoring the wavelength profile of the output of the source. Certain beam combining arrangements which may be used with the optical source use diffraction gratings which force the wavelength at which each core operates to differ with position in the linear array. Thus the cores may be positioned within the fibre to give a desired combination of output wavelengths.

Each of the plurality of cores may be configured to emit output radiation in a beam having a single spatial mode. If combining of the beams into a single output is desired, this feature allows a single mode single output beam to be readily achieved.

Sources having a plurality of cores may further comprise a beam combiner operable to combine the output radiation emitted by each of the plurality of cores into a single output beam. In such a source, each of the plurality of cores may operate at different wavelength and the beam combiner comprises a collimating lens and a diffraction grating arranged such that the output of each core is diffracted by a common angle to form a single output beam. Beam combiners of this kind are well-suited for combining beams emitted from a linear array of sources. They are also able to maintain the beam quality of the individual beams, so that an output combining a plurality of single mode beams can be near-diffraction limited.

In an alternative embodiment, the one or more optical fibre cores comprises a single core having an elongate cross-section. A core of this type does not give a single mode output, but does allow an equivalent core area to be provided in a smaller physical area than is possible with multiple cores, so that power scaling is still effective, and may be greater than would possible with a multiple core fibre of the same size.

The optical fibre may have an elongate cross-section with long sides which are substantially flat. A fibre of this shape allows the core or cores to be relatively close to the outside surface of the fibre, which offers improved heat removal. Flat surfaces allow good contact to be made between the fibre and a heat sink, so that heat removal may be efficient. Good dissipation of heat is important in achieving efficient performance and limiting heat-induced damage.

The optical fibre core or cores may be positioned asymmetrically with respect to the long sides of the fibre so as to facilitate removal of heat arising from absorption of the pump radiation. Any such heat can be more readily absorbed by a heat sink if the heat is generated closer to the fibre surface.

The active ions in the optical fibre core or cores may comprise at least one of: neodymium, ytterbium, erbium, thulium or other rare earth elements. For example, neodymium or ytterbium allow outputs with wavelengths around 1 μm to be generated, erbium and ytterbium together give wavelengths around 1.5 μm, and thulium gives wavelengths around 1.8 to 2.1 μm. Fibres having rare earth dopants have broad gain bandwidths which can be exploited by use of diffraction-grating based beam combiners, which force multiple cores to oscillate at different wavelengths. Furthermore, in the case of multiple cores, the various cores may be doped with different active ions or combination of active ions, to give a multi-wavelength output.

The beam shaping optics may comprise a light concentrator operable receive the pump radiation from the laser diode stack and reflect the pump radiation multiple times to produce a beam of reduced dimensions. This is a simple way of achieving the desired elongate beam shape.

The multiple reflections may be achieved by the use of one or more mirrored surfaces, or alternatively by total internal reflections within a prism. The latter approach potentially offers lower loss.

The beam shaping optics may further comprise a cylindrical lens located in front of the light concentrator and operable to focus the pump radiation as to reduce the amount of multiple reflections. This configuration also reduces losses, owing to the reduction in the amount of reflections occurring in the light concentrator.

Furthermore, the light concentrator may be configured such that the beam of pump radiation is produced with beam divergence angles which are substantially equal in all directions.

A second aspect of the present invention is directed to an optical system comprising two or more sources of optical radiation according to any preceding claim, and arranged so that the inner claddings in which the optical fibre cores are positioned are located side-by-side where the output radiation is emitted. This offers a way of further scaling the overall power achievable within a single system.

A third aspect of the present invention is directed to a method of generating optical radiation comprising:

generating pump radiation from a laser diode stack comprising one or more laser diode bars;

focusing the pump radiation into a beam with elongate cross-section; and

coupling the pump radiation into at least one end of an optical fibre having an inner cladding of elongate cross-section so that the pump radiation passes through the inner cladding and is absorbed by one or more optical fibre cores doped with active ions and having an overall elongate cross-section arranged parallel to the elongate cross-section of the inner cladding, so as to generate and emit output radiation by stimulated emission.

Key requirements for power scaling and maintaining good beam quality in a fibre laser are:

(a) an efficient means for in-coupling pump power from high power diode bar stacks; and/or

(b) a fibre inner cladding geometry which allows efficient in-coupling of pump power from high power diode bar stacks and allows efficient heat removal; and/or

(c) an arrangement of multiple active ion doped cores within an inner cladding which can efficiently absorb the pump light and which act as waveguides for the laser radiation, and which preferably should allow selection of a combined output laser beam which is of good beam quality, preferably a diffraction limited single spatial mode output beam.

The power scaling approach according to embodiments of the present invention incorporates the above features to overcome the limitations of the prior art.

An embodiment of the present invention provides a high power diode pump source comprising one or more diode bar stacks for producing high power pump radiation, a pump beam collection and beam shaping means for reducing the transverse beam dimensions of the pump beams such that the beam size in a first direction is much smaller than the beam size in a second (orthogonal) direction, a fibre of elongated cross-sectional shape said fibre having a size in a first direction which is smaller than the size in a second direction allowing efficient in-coupling of the pump radiation from said pump source, the perimeter surface in the second direction being substantially flat to allow efficient heat removal, said fibre also comprising multiple waveguiding cores of circular cross-section containing dopant ions to produce laser emission and also comprising means for combining the resultant laser beams emitted from said cores into a single beam of good beam quality.

This, and other embodiments, have many advantages over previous techniques described above in that it can be of very simple construction and allows scaling of laser power in a high quality beam, with simple thermal management. A further advantage over previous schemes for scaling fibre laser powers is that it allows the use of very high power diode bar stacks as pump sources with simple in-coupling optics, minimising complexity and greatly reducing the number of pump sources required for high power operation. This allows efficient and low cost power scaling compared to previous power scaling approaches. In addition, since the positions of the fibre cores are fixed during the fibre preform fabrication stage, they can be specified to form a linear array with very little deviation from a straight line, allowing a very simple and low cost alignment procedure to be used. The use of a linear array of laser ion doped cores in this invention allows efficient absorption of the launched pump radiation and facilitates the combination of the laser beams from said cores into a single, high quality, high power laser beam.

Embodiments of the present invention preferably comprise a means for combining the laser beams from each core into a single high quality beam. Preferably, a laser according to the present invention comprises a diffraction grating to enforce laser operation of each core at a slightly different wavelength than its neighbouring core, said diffraction grating also combining the beams from each core inside the laser cavity into a single, high quality beam. The cores may be doped with rare earth ions: neodymium or ytterbium to provide laser emission in the 1 μm spectral region; erbium and ytterbium co-doping to provide laser emission the 1.5 μm spectral region; and thulium to provide laser emission in the ˜1.8 to 2.1 μm spectral region, to meet the requirements of various applications. In addition, the cores can be placed in very close proximity (much closer than for individual single core fibres), if desired, allowing a small wavelength separation of adjacent cores to be selected for a given pitch of diffraction grating and hence the use of more cores for further power scaling. Preferably, the cores are designed so they each produce a single spatial mode beam, which is combined into a single high quality beam with beam propagation factor, M²≈1. Thus, a laser or optical source according to embodiments of this invention can provide high average power in a high brightness beam, serving the needs of many applications.

### BRIEF DESCRIPTION OF THE DRAWINGS

For a better understanding of the invention and to show how the same may be carried into effect reference is now made by way of example to the accompanying drawings in which:

FIGS. 1(a) and 1(b) are schematic plan and side views respectively of a diode laser bar stack for use in embodiments of the present invention, with a first arrangement of beam collection and beam shaping optics;

FIGS. 2(a) and 2(b) are schematic plan and side views respectively of a diode laser bar stack with a second arrangement of beam collection and beam shaping optics;

FIGS. 3(a) and 3(b) are schematic plan and side views respectively of a diode laser bar stack with a third arrangement of beam collection and beam shaping optics;

FIGS. 4(a), 4(b), 4(c), 4(d) and 4(e) are schematic end views of multi-core ribbon optical fibres with different arrangements of the cores according to different embodiments of the present invention;

FIGS. 5(a) and 5(b) show schematic end views of the optical fibre with different examples of outer cladding designs;

FIG. 6 is a schematic end view of the optical fibre, where multiple fibres are joined or placed in close contact at one or both ends to provide a combined fibre of greater width;

FIGS. 7(a) and 7(b) are schematic side and plan views respectively of an embodiment of the invention;

FIGS. 8(a) and 8(b) are schematic side and plan views respectively of a second embodiment of the invention;

FIGS. 9(a) and 9(b) are schematic side and plan views respectively of a third embodiment of the invention;

FIGS. 10(a) and 10(b) are schematic side and plan views respectively of a fourth embodiment of the invention;

FIGS. 11(a) and 11(b) are schematic side and plan views respectively of fifth embodiment of the invention;

FIG. 12 is a schematic cross-sectional view through a sixth embodiment of the invention;

FIG. 13 is a schematic view of a seventh embodiment of the invention; and

FIG. 14 is a schematic end view of a further embodiment of a ribbon fibre.

### DETAILED DESCRIPTION

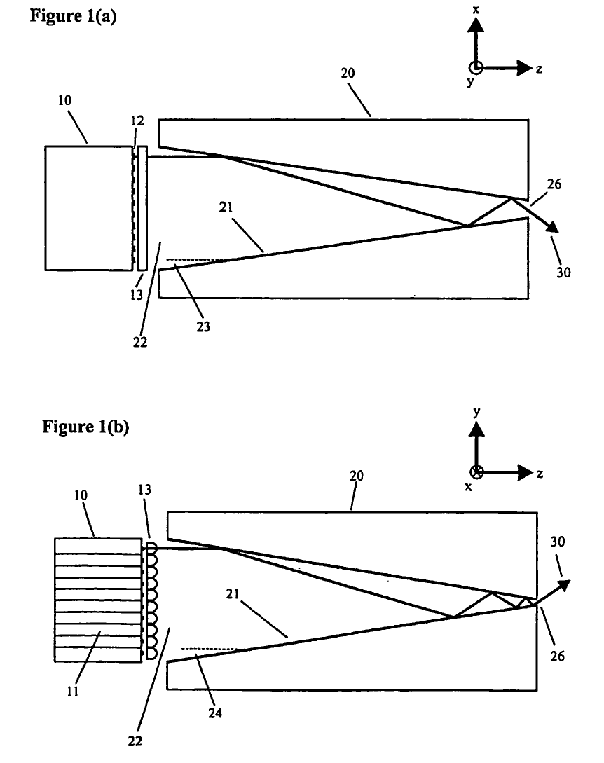

With reference to FIGS. 1(a) and 1(b), diode laser radiation from a high power diode bar stack 10 comprising one or more diode laser arrays (diode bars) 11 of lower power diode lasers 12 is incident on an array of cylindrical collimating lenses 13, positioned so that each cylindrical lens collimates the laser radiation from the adjacent diode bar in the fast beam divergence direction y (perpendicular to the diode laser junction), and preferably so that the height of each collimated beam is approximately equal to the distance between adjacent diode bars. Laser radiation from the diode bar stack is then incident on a light concentrator 20, with an entrance aperture 22 of width in the x-direction not less than, and preferably equal to the diode bar stack beam width in the x-direction, and width in the y-direction not less than, and preferably equal to the diode bar stack beam width in the y-direction. The light concentrator comprising highly reflecting surfaces 21 inclined at angles 23 and 24 in the x-z and y-z planes respectively, at which the laser radiation experiences multiple reflections during its passage through the concentrator (the optical path of one light ray 30 is shown by way of example only), and chosen to produce a high intensity beam of rectangular cross-section and small area at the exit aperture 26 which has a size in a first direction (x-direction) which is much larger than the size in a second direction (y-direction). In a preferred design the light concentrator is fabricated from metal with a high reflectivity metallic coating, and the angles 23 and 24, the length of the concentrator and the dimensions of the exit aperture are chosen to produce a rectangular beam at the exit aperture with roughly equal beam divergence angles in the x and y-direction, with minimal reduction in brightness.

For example, a typical diode bar stack comprising ten diode bars, each approximately 10 mm long and separated from each other by ˜1.7 mm, can produce diode laser radiation with continuous wave power of 200-400 W and even higher pulsed powers. With the appropriate design of cylindrical lens array 13, a beam height H of approximately 1.2 mm can be used without incurring significant loss due to cross-talk (i.e. overlapping of the beams at the collimating lens). Each lens of the lens array 13 preferably has one or both surfaces with an acylindrical profile and is carefully aligned to minimise degradation in diode laser beam quality in the y-direction due to lens aberration, whilst maximising light collection efficiency. A beam propagation factor in the y-direction, M_{y}²<5 for each collimated diode bar is easily achievable and a beam propagation factor, M_{y}²≈1 is possible with careful optimisation of lens design and alignment. The resulting combined beam from the diode stack will have a beam quality factor in the y-direction roughly given by M_{yr}²≈NsM_{y}²/H, where N is the number of bars in the stack and s is the centre-to-centre spacing of the diode bars in the y-direction. For a typical ten bar diode stack with cylindrical lens array for collimation in the y-direction, ˜14<M_{yr}²<70.

In the orthogonal direction (x-direction) parallel to each diode bar array, the beam quality factor Mₓᵣ² for the diode stack is approximately equal to the beam quality factor Mₓ² for a single diode bar. For a typical diode stack, Mₓᵣ²≈2500. This large mismatch in the beam quality factors for orthogonal directions would make focussing of the diode bar stack output to a high intensity circular beam very difficult. The large difference in the beam quality factors for orthogonal planes implies that the beam can be converted to a rectangular beam of much higher intensity than could be achieved for a circular beam. If the final beam has a beam divergence θ (half-angle) selected so that sin(θ) is less than the numerical aperture of the inner cladding of the fibre laser, as would be required for low loss guiding of the pump radiation, then the highest intensity (or smallest area) beam would have a rectangular cross-section with aspect ratio, Wₓ/W_{y}≈Mₓᵣ²/M_{yr}², where Wₓ and W_{y} are the full widths of the beam in the x- and y-directions respectively.

The performance of a cladding pumped fibre laser is determined by many factors, including fibre losses, the launched pump power and pump absorption efficiency. The use of fibre designs which minimise the inner cladding-to-core area ratio without compromising pump launch efficiency is often crucial as this allows for the pump to be absorbed efficiently in a short length of fibre, thereby reducing cavity losses and reducing nonlinear effects which can cause self pulsing and damage to the fibre. Thus, the properties of the diode stack pump source imply the use of a ribbon fibre with an inner cladding or pump guide of elongate or rectangular cross-section with aspect ratio, w/t≈Wₓ/W_{y}≈Mₓᵣ²/M_{yr}². In this way, the limitations of the high power diode stack pump source can be overcome, rendering it ideal for power scaling of fibre lasers with the appropriate rectangular inner cladding design and multiple laser ion doped cores. As an example, a fibre with inner cladding of numerical aperture 0.4 in both x-z and y-z planes, requires a pump beam with beam divergence angles in orthogonal planes, θₓ≈θ_{y}<0.46 rad. If M_{y}²=5, then as a rough guide the minimum area pump beam would have beam widths approximately given by Wₓ≈2Mₓᵣ^{2λ}ₚ/πθₓ≈3 mm and W_{y}≈2M_{yr}²λ/πθ_{y}≈63 μm for a pump wavelength λₚ of 915 nm. For efficient in-coupling of the pump radiation the fibre inner cladding would need a width in the x-direction w >Wₓ and a thickness in the y-direction t >W_{y}. For a diode stack with more bars, a fibre with inner cladding of greater thickness t would be required, but in most practical situations the inner cladding thickness t would always be much smaller than its width w. Thus, with this approach very high pump powers from diode bar stacks can be efficiently launched into fibres. In all cases, the pump light concentrator 20 is placed in close proximity to the collimating lens array 13 and is designed with entrance aperture dimensions to allow efficient collection of the pump radiation after the collimating lens array 13, and its length and inner reflecting surface inclination angles 23 and 24 are chosen to minimise losses and change in beam quality factors, Mₓᵣ² and M_{yr}², to produce an elongated rectangular beam at the exit aperture 26.

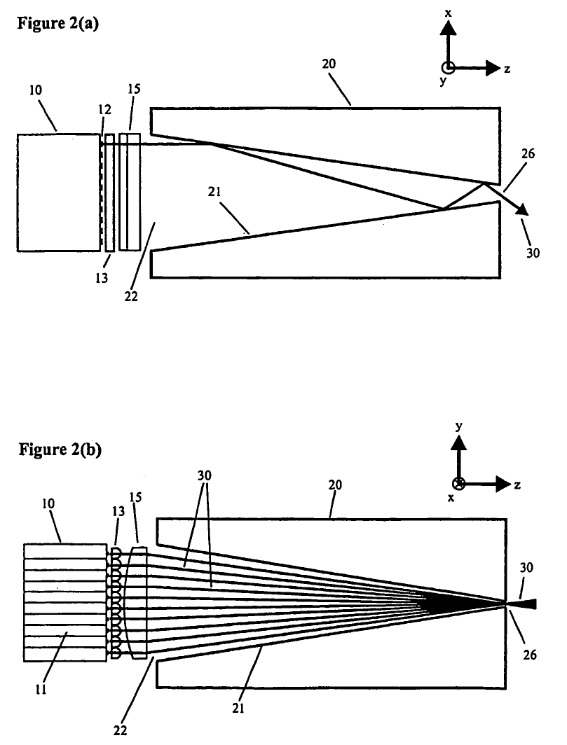

In another design of pump beam collection and beam shaping optics, shown in FIGS. 2(a) and 2(b), and which is otherwise the same as the design of FIGS. 1(a) and (b), a cylindrical lens 15 of focal length roughly equal to, or slightly longer than, the length of the light concentrator 20 is placed after the lens array 13 and immediately before the light concentrator 20 to focus the pump beam in the y-direction. This helps to reduce reflection losses at reflecting surfaces 21 and reduces the degradation in beam quality in the y-direction for the beam emerging from the light concentrator.

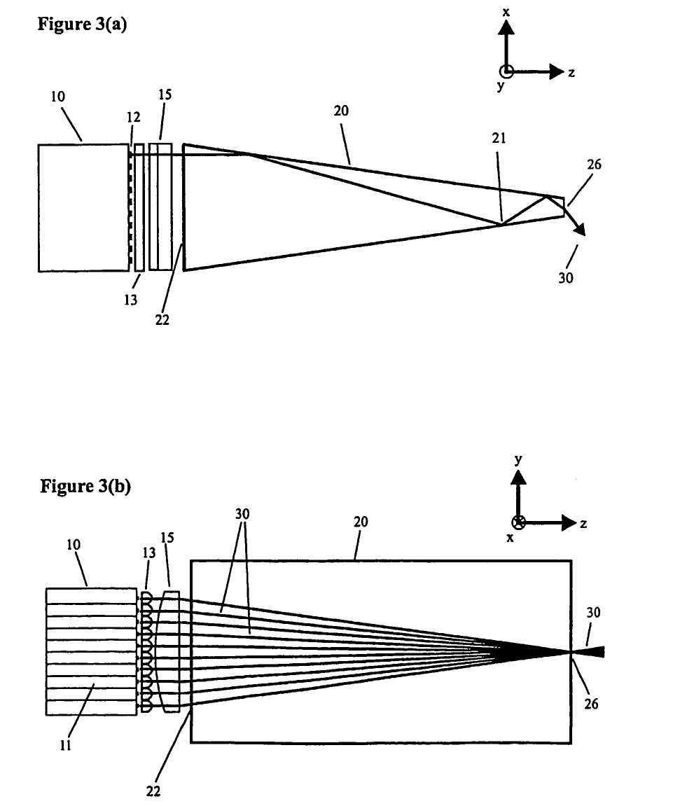

In another design of pump beam collection and beam shaping optics, shown in FIGS. 3(a) and 3(b), the light concentrator 20 is fabricated from a transparent material (e.g. silica glass) in the form of a prism with entrance aperture 22 roughly equal to the pump beam size in the x-direction (parallel to the diode junction), and exit aperture 26 of much smaller width (typically in the range 1 mm to 3 mm), which acts to reduce the beam size in the x-direction only after multiple total internal reflections at surfaces 21. The beam size in the y-direction (perpendicular to the diode junction) is reduced by focussing with a cylindrical lens 15 of focal length designed to produce a beam waist at or just beyond the exit aperture 26. This design of pump beam reshaping and delivery optics has the attraction over the configurations shown in FIGS. 1(a) and 1(b) and 2(a) and 2(b) that the losses can be lower, since the diode pump light is reflected at the surfaces 21 of the concentrator 20 by total internal reflection.

Alternatively, a compound lens system could be used to appropriately focus and shape the output of the diode bar stack into a beam with the desired elongate cross-section.

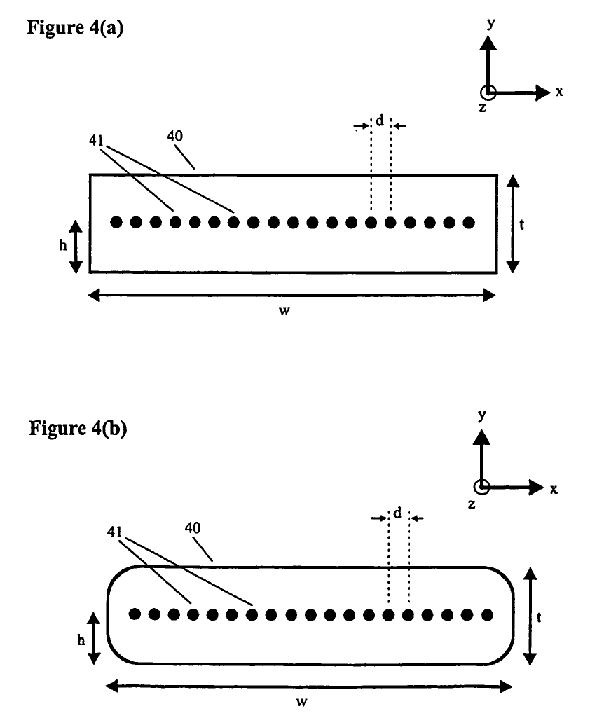

The pump light 30 emerging from the light concentrator is launched into the inner cladding 40 of a multi-core ribbon fibre (preferred designs of which are shown in FIGS. 4(a), (b), (c), (d) and (e)) by positioning the fibre close to or just inside the exit aperture 26 of the light concentrator. In a preferred embodiment (shown in FIG. 4(a)) the inner cladding has a rectangular cross-section or nearly rectangular (elongated) cross-section and contains multiple (two or more) waveguiding cores 41 doped with laser ions (for example, neodymium or ytterbium to allow laser oscillation at wavelengths around 1 μm, erbium and ytterbium to allow laser oscillation at wavelengths around 1.5 μm, or thulium to allow laser oscillation at wavelengths around 1.8 to 2.1 μm). In a preferred configuration the core diameter and its refractive index are chosen to allow selection of a single spatial mode. The cores 41 are arranged in a linear array in the x-direction (i.e. parallel to the diode bar array direction and parallel to the elongate cross-section of the inner cladding), so together they have an overall elongate-cross section. Although FIG. 4(a) shows a fibre with rectangular cross-section, in reality, surface tension in the fibre drawing process is likely to result in a fibre with slightly rounded comers, as shown in FIG. 4(b). Also, although the cores shown in FIGS. 4(a) to 4(e) are of circular cross-section, other cross-sections may be used, such as square or rectangular. In one arrangement the cores have equal separations d and are located midway between the long faces of the inner cladding (FIGS. 4(a) and 4(b)). In another arrangement the cores are located much closer to one of the two long faces of the inner cladding to facilitate heat removal and minimise the temperature rise in the cores when pumped by the diode stack (FIG. 4(c)). In a further arrangement, shown in FIG. 4(d), the cores are located much closer together and do not span the entire width w of the ribbon fibre. This arrangement allows for efficient in-coupling of diode bar stacks, whilst reducing the lasing bandwidth for wavelength-combined cores. In a yet further arrangement (shown in FIG. 4(d)) the cores 41 are arranged in a linear array but are spaced by different distances (d₁, d₂, d₃, etc), to allow the output wavelength spectrum of the laser to be tailored to a particular application which requires multiple specified wavelengths. In all designs the width w and thickness t of the inner cladding 40 are approximately equal to or slightly larger than the output beam dimensions of the light concentrator to allow pump light to be efficiently launched into the ribbon fibre. Alternatively, the pump light emerging from the light concentrator may be imaged on to the end face of the fibre by an arrangement of lenses.

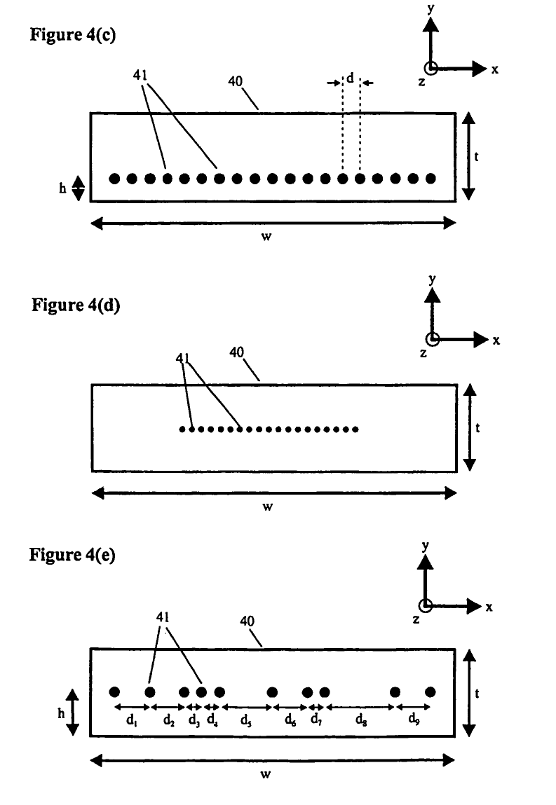

The fibre also comprises an outer cladding (shown in FIG. 5) of lower refractive index than the inner cladding to ensure waveguiding of the diode pump radiation in the inner cladding. In a preferred configuration the outer cladding 42 is formed from a single material and surrounds the inner cladding 40 as shown in FIG. 5(a). The choice of inner cladding material should be such that the inner cladding has a high numerical aperture preferably greater than 0.4. In one configuration, shown in FIG. 5(b), the outer cladding is formed from different materials (each of lower refractive index than the inner cladding) which adhere to or are placed in contact with the surfaces of the inner cladding. In a preferred configuration the inner cladding 40 is placed on a metal heat sink 43 which has been coated with a thin layer of lower refractive index material 42 with an additional coating of the same or a different lower refractive index materials 44 and 45 applied to the outer surface of the inner cladding. One or more of these materials may be a liquid or air.

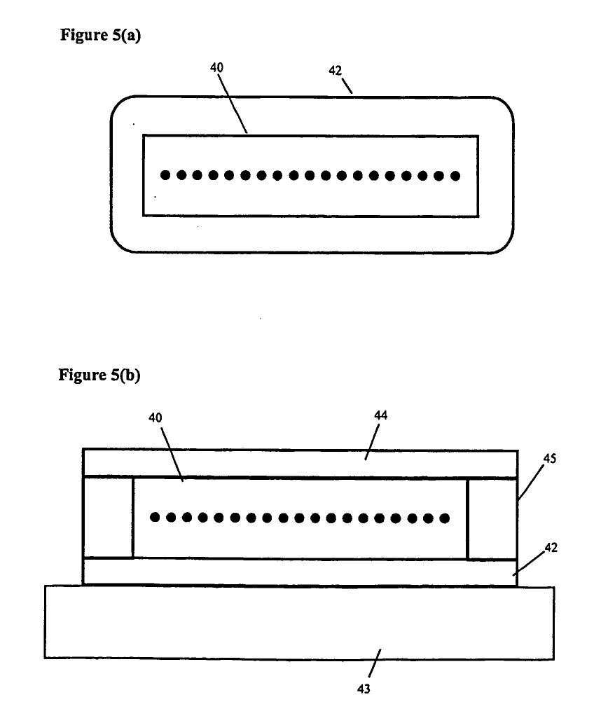

To increase the width of the inner cladding two or more ribbon fibres each comprising a linear array of active laser ion doped cores in a rectangular or elongated inner cladding (such as those shown in FIGS. 4(a), (b), (c), (d) (e)) can be combined by placing one or both ends of each fibre in contact with the others. FIG. 6 shows, by way of example only, three fibres arranged in this manner. This allows further power scaling of the combined fibre lasers by increasing the number of lasing cores and allows additional or higher power diode bar stacks to be launched into the inner cladding of the fibres. It also allows any restrictions on the aspect ratio w/t for a single fibre due to fabrication limitations to be overcome.

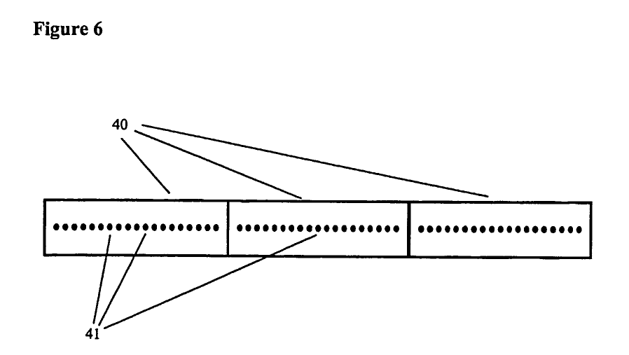

FIGS. 7(a) and 7(b) show schematic side and plan views respectively of a preferred embodiment of this invention for achieving simultaneous laser operation of each of the laser ion doped cores. Pump radiation from a high power diode bar stack 10 is collected and reshaped into an intense elongated rectangular beam in the manner already described and is launched into the inner cladding of a multi-core ribbon fibre 40. In FIGS. 7(a) and 7(b) the fibre has five cores, by way of example only. In practice, the choice of the number of cores will depend on many factors including the inner cladding and core sizes, the spectroscopic properties of the lasing ion, the diode bar stack's wavelength and the intended fibre laser output power. Mirror 50 is selected to have high reflectivity at the lasing wavelengths and high transmission at the pump wavelength and is butted to the pump in-coupling end of the fibre to provide the feedback necessary for efficient laser operation. Alternatively, mirror 50 can be replaced by multilayer dielectric coating with high reflectivity for the lasing wavelengths and high transmission for the pump wavelength placed directly on the pump in-coupling end of the fibre, or by in-fibre Bragg gratings written in each of the fibre's cores to provide the required reflectivity characteristics at the lasing and pump wavelengths. A further alternative, for use with the prism light concentrator for FIGS. 3(a) and 3(b), is to provide a coating, such as a dielectric coating, on the end surface of the prism, and to but the fibre end up against the coating. The coating is highly transmitting at the pump wavelength, and highly reflecting at the lasing wavelengths to provide the feedback necessary for operation. An advantage of this is that the fibre may be moved to a new part of the prism surface in the event of damage to the coating.

The fibre is also preferably placed on a heat sink 43, which may be liquid cooled, for removal of the heat generated during the laser pumping cycle. The elongated rectangular geometry of the fibre allows for easy heat sinking and hence effective heat removal, this being another advantage of the present invention over the prior art. The length of the fibre is preferably chosen to ensure efficient absorption of the pump radiation from the diode stack and efficient laser operation on each of the lasing cores. The laser output face 46 of the fibre is prepared (e.g. by polishing) to provide the further feedback required for laser oscillation. If required, an increase in feedback (i.e. reflectivity of the fibre end) may be achieved by applying a multilayer dielectric coating to the end face with the desired reflectivity characteristics, or by writing Bragg gratings in the cores of the fibre. This embodiment (shown in FIGS. 7(a) and 7(b)) of the invention provides a means for producing high laser output power in multiple laser beams 60. The beam quality factor M_{cx}² of the combined output beam in the x-direction is roughly given by M_{cx}²≈qdM_{fx}²/φ_{f}, where q is the number of cores, d is the centre-to-centre spacing of the cores, φ_{f} is the core diameter and M_{fx}² is the beam quality factor of the laser beam from a single core. In the orthogonal plane (i.e. perpendicular to the fibre array), the beam quality factor M_{cy}² for the combined beam is approximately the same as that for a single beam (i.e. M_{cy}²≈M_{fy}²). In a preferred embodiment each core is designed to produce a single spatial mode beam, under which circumstances M_{fx}²≈M_{fy}²≈1. The beam quality in the x-direction can be improved by a factor ˜d/φ_{f} by using an array of collimating lenses positioned immediately after the fibre to simultaneously collimate each beam from the array of lasing cores.

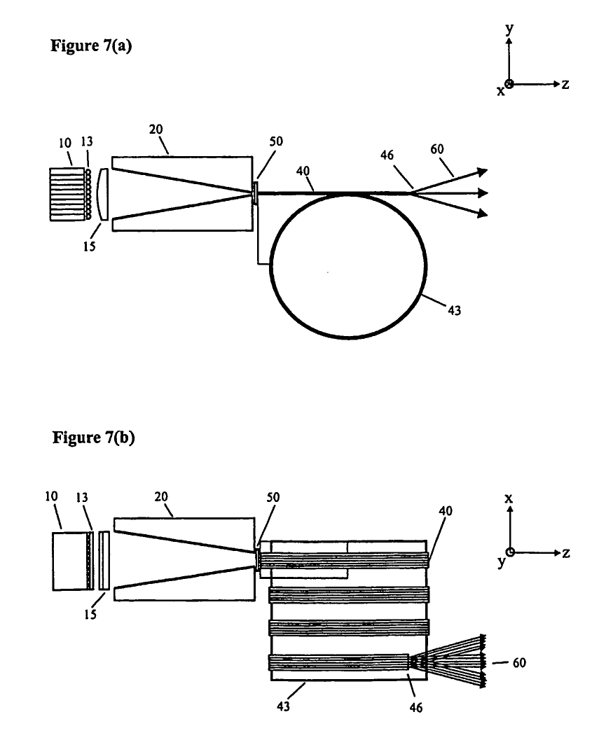

In another preferred embodiment of the invention (shown in FIGS. 8(a) and (b)) the fibre laser also incorporates a means for combining the beams from individual fibre lasers into a single high quality beam. This is achieved by simply adding an external cavity comprising a collimating lens 52, a diffraction grating 53 and an output coupling mirror 55 with partial transmittance at the lasing wavelengths. The collimating lens 52 is preferably antireflection coated at the lasing wavelengths and is positioned at a distance approximately equal to its focal length from the end face 46 of the fibre. Alternatively, the collimating lens 52 could be replaced with alternative collimating arrangements, such as a compound lens comprising a plurality of lenses. This arrangement can be used to reduce aberration. The diffraction grating 53 is preferably blazed to give high reflectivity over the range of lasing wavelengths into the first order diffracted beam and is positioned at a distance approximately equal to the focal length of the collimating lens 52 from the lens as shown. The diffraction grating is preferably aligned so that the laser radiation from each core is diffracted into the −1 first order beam with the smallest possible angle between the incident and diffracted beam which allows the combined diffracted laser beam to pass by the side of lens 52 and its holder without attenuation. The partially transmitting mirror 55 is preferably aligned to retroreflect the combined first order diffracted beam, thereby providing the feedback required for laser action in each of the cores.

The principle of operation of the fibre laser is as follows: Each lasing core operates independently of the other cores using the extended cavity to provide the feedback for laser oscillation in each core and with each laser providing an output from the partially transmitting mirror 55. The orientation of the output coupler 55 with respect to the diffraction grating 53 defines a common angle of incidence θᵢ on the diffraction grating for all laser beams fed back from the output coupler. The action of the diffraction grating is to automatically select the wavelength of each lasing core so that each of the laser beams fed back by the output coupler 55 is diffracted at the diffraction grating 53 with slightly different angles θ_{dj} with respect to the normal, and hence is focussed by lens 55 into the corresponding core, thereby completing the feedback loop required for laser operation. As a rough guide the lasing wavelength λⱼ of the jth core is given by λⱼ=Λ[sin(θᵢ)+sin(θ_{dj})], where Λ is the line spacing on the diffraction grating. Thus, the wavelength separation Δλ of adjacent lasing cores is approximately given by Δλ=Λ(sin(θ_{dj})-sin(θ_{d(j+l)}))≈Λdcos(θ_{d})/f (providing d/f <<1), where f is the focal length of lens 52, θ_{d} is the average diffraction angle and d is the centre-to-centre separation of adjacent lasing cores (as shown for example in FIGS. 4(a),(b) and (c)). Thus by careful selection of the fibre design, core spacing, collimating lens diameter and focal length, and diffraction grating size and line spacing it is possible to select the wavelength separation of adjacent cores to be much smaller than the gain bandwidth for the laser transition αλ_{L}. The maximum number of cores allowable roughly scales according to Δλ_{L}f/Λdcos(θ_{d}) and with standard components can be made to be greater than 100, if required. In a preferred configuration the fibre end face 46 is prepared so as to suppress feedback which might otherwise compete with the feedback due to the external cavity thereby limiting the effective linewidth over which the external cavity can act to select the cores' wavelengths. This may be achieved by, for example, coating the fibre end face 46 with an antireflection coating at the lasing wavelengths, or by angle polishing the end face 46, or by optically contacting a glass block (preferably with the same refractive index as the core) on to the end face 46 of the fibre. The cores' waveguiding properties are preferably selected so that each core provides only a single spatial mode beam, with the result that the combined output beam 61 is nearly diffraction limited with very good beam quality. The cores can be doped with different active laser ions to allow laser oscillation in different wavelength regimes. For example, neodymium or ytterbium ions can be used to provide lasing wavelengths in the ˜1 μm regime, co-doping with both erbium and ytterbium ions can be used to provide lasing wavelengths in the 1.5 μm regime, and thulium ions can be used to provide lasing wavelengths in the 1.8 to 2.1 μm regime, thereby serving a number of different applications. Additionally, other rare earth ions can be used alone or in co-doped combinations to give other wavelengths, as desired. Indeed, different individual cores within the fibre may be doped with different active ions, to give a multi-wavelength source.

In an alternative configuration the cores separations can be tailored to select laser operation on a number of specific wavelengths combined into a single high power laser beam (for example by using the fibre design shown schematically in FIG. 4(e)) as required by a particular application (e.g. pumping of a solid state laser). In summary, this approach for power scaling which combines the ability to in-couple high pump powers from diode bar stacks into a ribbon fibre with highly elongated rectangular inner cladding with a novel linear multicore array and means for intracavity wavelength combining the laser beams from each core, exploiting the broad gain linewidths that are typical of in glass hosts to increase the combined core area, allows very high output powers (>1 kW) to be obtained in a single high quality laser beam. Furthermore, the highly elongated rectangular fibre geometry allows for relatively easy heat sinking and hence effective removal of the unwanted heat generated as part of the lasing pumping cycle.

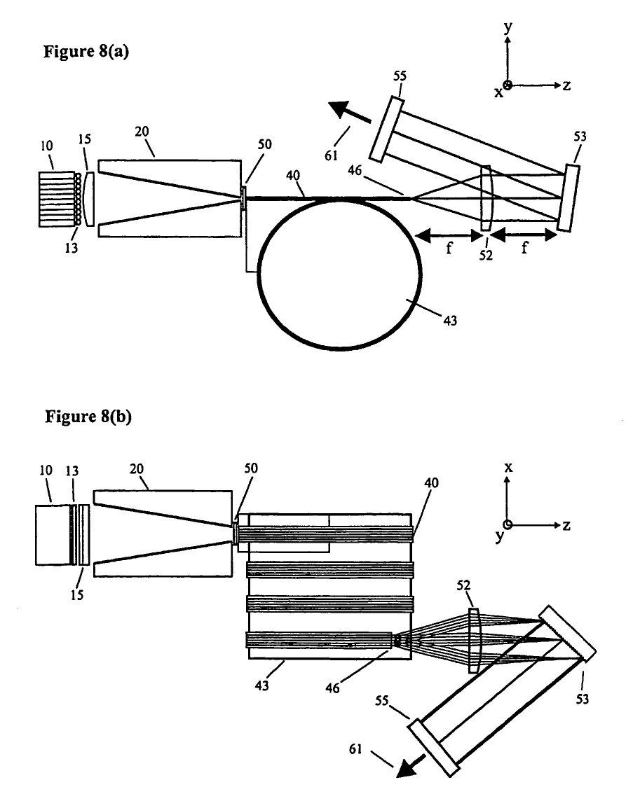

In another preferred embodiment, shown in FIGS. 9(a) and (b), the fibre laser can be operated in pulsed (Q-switched) mode to achieve a combination of high peak power and high average power by inserting a Q-switch 58 into the external cavity between the diffraction grating 53 and the output coupler 55.

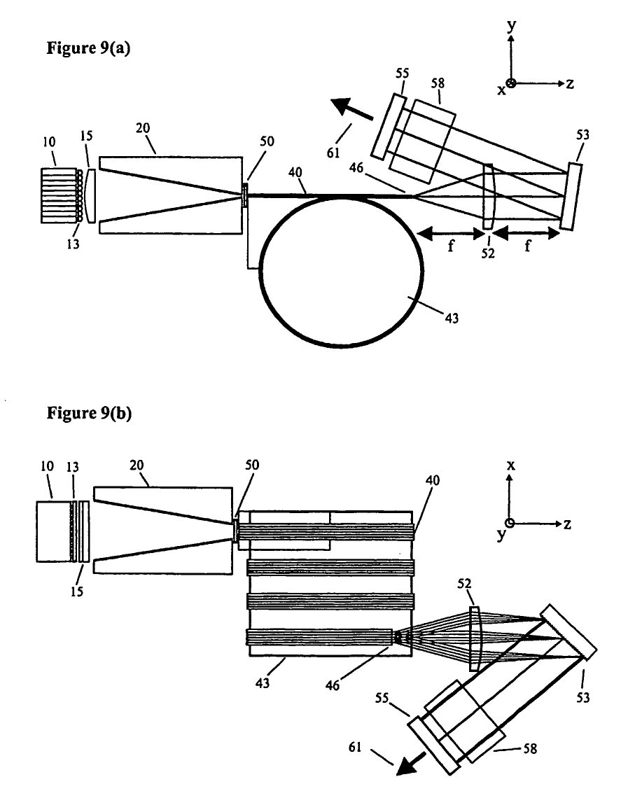

In another preferred embodiment, shown in FIGS. 10(a) and 10(b), wavelength combining of the multiple cores' output beams is achieved external to the laser cavity. In this case, the feedback for laser oscillation for each core is achieved by in-fibre Bragg gratings at one or both ends of the fibre and with grating period selected to produce wavelength dependent feedback at the desired wavelength. Additional feedback for laser oscillation (if required) being provided by a mirror or a coated or uncoated perpendicularly polished fibre end face 46. The operating wavelengths of the individual cores are selected according to the expression, λⱼ=Λ(sin(θᵢⱼ)+sin(θ_{d})), so that when the beams are collimated by a lens 52 of focal length f, placed at a distance approximately equal to f from the fibre output end, and incident at angles θᵢⱼ on a diffraction grating 53 of line spacing A placed at a distance approximately equal to f from the lens 52, they are diffracted from the diffraction grating at a common angle θ_{d} forming a single laser beam 61 of high quality. Preferably, the cores are each designed to produce a single spatial mode output beam, with the result that the combined laser beam 61 is nearly diffraction limited.

Other approaches may be used to combine the beams emitted by the individual cores, as alternatives to the spectral beam combining methods already described. For example, the cores may be configured to each emit at the same wavelength, and an external phase-locking arrangement may be provided to phase-lock these single frequency outputs into a single coherent beam. This is relatively complex to achieve, but offers the advantage that control of the phase in this way allows the beam to be directed.

Alternatively, phase-locking may be achieved internally, by allowing a certain amount of cross-talk to occur between the fibre cores.

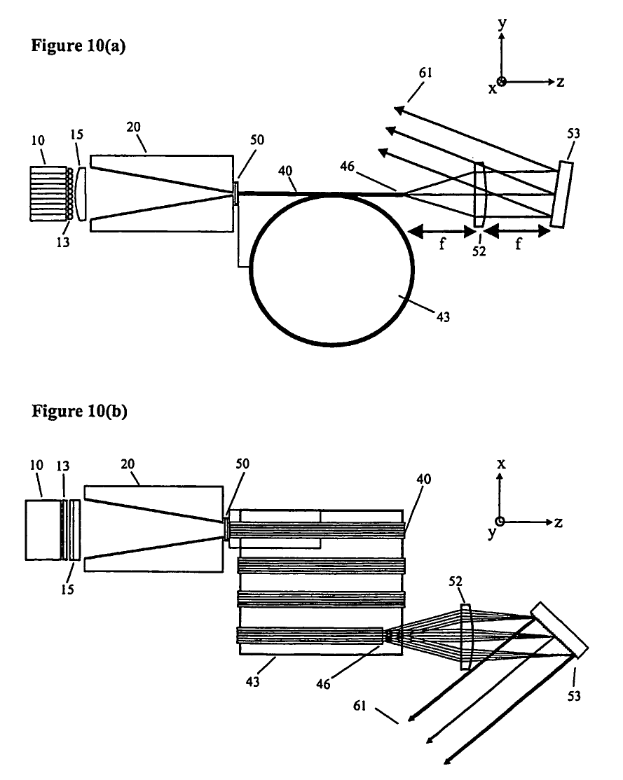

The power scaling approach according to embodiments of the present invention as described in FIGS. 1, 2, 3, 4, 5, 6, 7, 8, 9 and 10 can be simply extended to allow pumping by more than one diode bar stack. In one preferred embodiment (shown in FIGS. 11(a) and 11(b)) multiple diode stack pumped fibres (three in this example), each comprising a single diode stack with beam collection and reshaping means 25 and ribbon fibre with elongated rectangular inner cladding containing a linear array of cores 40, are combined into a single beam 61 by positioning the fibre ends 46 adjacent to each other so that their cores form a longer linear array (for example, as shown in FIG. 6). The output beams from said cores can be combined into a single high quality beam via the use of an external cavity containing a collimating lens 52, a diffraction grating 53 and partially transmitting output coupling mirror 55. As before, the action of the external feedback cavity is to enforce each core to operate at a slightly different wavelength within the gain bandwidth of the active ion so that the resulting beams are combined intracavity at the diffraction grating to form a single output beam 61 of high quality. To suppress feedback from the fibre ends 46 and to hence maximise the number of fibre lasers which can be combined in this way, the fibre end faces should preferably be antireflection coated, angle polished or placed in optical contact with a polished glass block. High peak power pulsed operation of the combined laser source may also be achieved, if desired, by inserting a Q-switch in the external cavity between the diffraction grating 53 and the output coupling mirror 55.

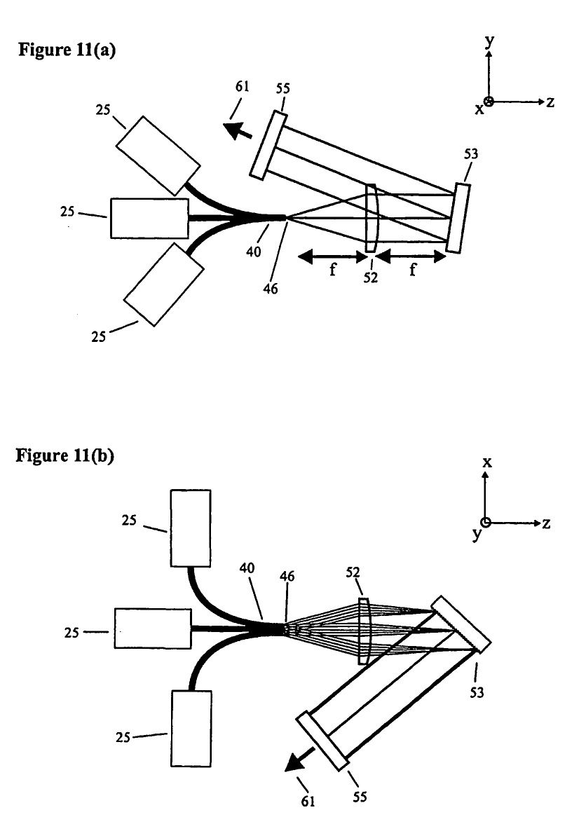

Alternatively, multiple diode bar stack pump sources can be coupled into a single fibre via the approach illustrated in FIG. 12. In this case single diode bar stacks are launched via the schemes shown in FIGS. 1(a) and 1(b), or 2(a) and 2(b) or 3(a) and 3(b), into ribbon fibres 48 with elongated rectangular pump guides and no cores, and these fibres are then placed in optical contact with ribbon fibres 40 containing a linear array of laser ion doped cores. In one preferred arrangement, shown in FIG. 12, the ribbon fibre with cores is wrapped around a metal heat sink coated with a low refractive index cladding material 42 and the coreless pump delivery fibres 48 are wound around on top of the ribbon fibre 40 with cores. A further protective low refractive index cladding layer 42 may then be wound around on top of the pump delivery fibres 48. The inner cladding of fibre 40 should preferably be fabricated from a material with refractive index, n_{c}, and the pump delivery fibre 48 fabricated from a material with refractive index nₚ, where n_{c}≧nₚ. In a preferred design both the inner cladding of fibre 40 and the pump fibre 48 are fabricated from silica. The outer cladding layer 42 should be fabricated from a material with lower refractive index than n_{c} and nₚ. In this design pump radiation in passes from the pump delivery fibre 48 into multiple core ribbon fibre 40 at the regions where the two fibres are in optical contact and hence pump radiation can be absorbed by the laser gain media in the cores. The large flat surfaces of fibres 48 and 40 allow for a large area of optical contact and hence efficient pump absorption in the multiple core ribbon fibre. In addition, the large flat surfaces of ribbon fibre 40 allow easy heat sinking and hence effective removal of unwanted heat generated within the cores. This approach allows the in-coupling of multiple diode bar stacks into the multiple core ribbon fibre, and via the use of an external cavity (as shown in FIGS. 8 and 9) allows very high continuous wave or pulsed powers in a single high quality beam to be achieved.

The various embodiments of the laser described herein above may be adapted for use as amplifiers. The requirement for this is that both the pump light from the diode stack and an optical signal to be amplified need to be coupled into the ribbon fibre. The embodiment of FIG. 12 is well-suited for this, as the ends of the ribbon fibres 40 with the active ion doped cores 41 are free, owing to the use of the additional core-less ribbon fibres 48 to receive the pump light from the diode stack. Hence, the signal to be amplified can be launched directly into an end of the ribbon fibre 49 with cores 41, using suitable coupling optics.

The embodiment of FIGS. 7(a) and 7(b) can also be used as a amplifier. In this case, because one end of the ribbon fibre 40 receives the pump light directly, the signal is most readily launched into the fibre 40 from its other end, being the end which emits the laser output in the laser embodiment.

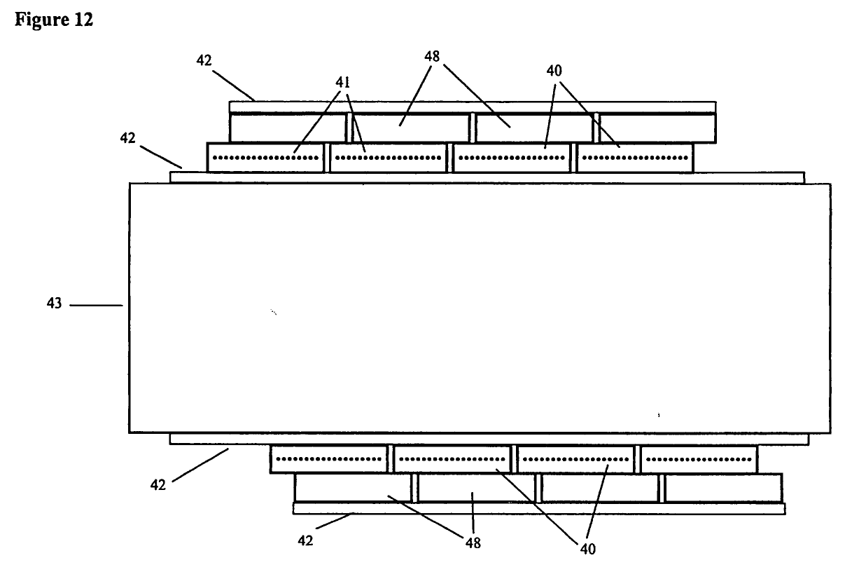

FIG. 13 shows a simplified schematic diagram of such an amplifier. The pump light 100 in form of a beam having an elongate cross-section, is generated from a pump source 102, which comprises a diode bar stack and light concentrating optics as described above. The pump light is launched into a ribbon fibre 40 having one or more cores, also as described above.

A mirror 104 is provided between the pump source 102 and the fibre 40, which is highly transmitting at the pump wavelength and highly reflecting at the signal wavelength. Alternatively, the mirror 104 can be replaced with a dielectric coating on the fibre end or the end surface of any prism used to concentrate the pump light, or by gratings written into the fibre, all as described above for the laser embodiments.

The signal is launched into the far end of the fibre 40 via a beam splitter 106, which directs part of the signal beam 108 into the fibre. Suitable beam shaping optics (not shown) are used to focus the signal beam to achieve efficient coupling.

In operation, the signal propagates along the fibre 40, and is amplified by the gain produced in the fibre cores by the pump light. On reaching the mirror 102, the amplified signal is reflected back down the fibre 40, and exits through the fibre end through which is was originally launched. The final amplified signal 110 is coupled out of the amplifier system through the beam splitter 106.

The amplified output of the amplifier may be combined into a single beam if desired. A beam combining method utilising an external phase-locking arrangement is well-suited, as it is likely that each of the cores will be operating at the same signal wavelength.

With both the laser and amplifier embodiments of the invention, a farther embodiment of the ribbon fibre 40 may be used.

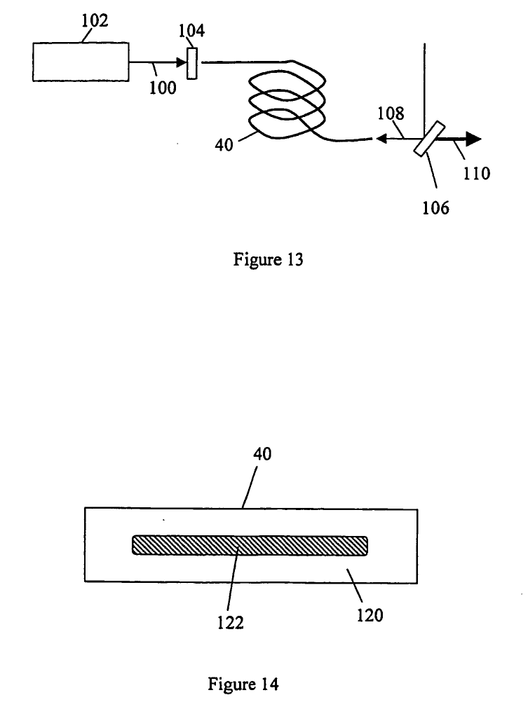

FIG. 14 shows a cross-sectional view of this embodiment of the fibre 40. In common with the earlier-described embodiments, the inner cladding 120 has a substantially rectangular, elongate cross-section, configured to efficiently receive pump light from a diode bar stack which is focussed into a beam of elongate cross-section. However, this fibre has a single core 122, also of elongate cross-section.

A core of this shape will not produce a single spatial mode output. However, the smaller core dimension can be chosen to be small enough for the output beam to be single mode in that dimension, while the longer dimension will be multimode. Hence, this type of fibre is not suitable for use with the spectral beam combiner described above, nor is it suitable if a single mode output is required. However, it still offers the power scaling advantages of the other embodiments, as the core area can be at least as big as the total core area of a plurality of individual cores. Indeed, the same core area can be provided in a smaller physical area, as the spacing needed between individual cores is not present. This may be advantageous in addressing any fibre fabrication limitations on the overall size of the fibre.

In summary, aspects of the present invention provide a laser system comprising one or more diode bar stack pump lasers, a means for efficiently in-coupling the pump radiation from said diode bar stacks into a ribbon fibre with a highly elongated rectangular inner cladding, said fibre further comprising a linear array of two or more waveguiding cores doped with active laser ions to provide gain for a range of lasing wavelengths, said laser system also comprising a means for combining the emitted laser beams from each lasing core into a single output beam with high power and good beam quality.

### REFERENCES

[1] C. Stewen, M. Larionov, A. Giesen and K. Contag, “Yb:YAG thin disk laser with 1 kW output power,” in Trends in Optics and Photonics, vol.34, (Optical Society of America, Washington, D.C.) (2000), p.35-41.

[2] A. K. Cousins, “Temperature and thermal stress scaling in finite-length end-pumped solid-state laser rods,” IEEE J. Quantum Electron., vol.28, (1992), p.1057-1069.

[3] R. A. Hayward, W. A. Clarkson, P. W. Turner, J. Nilsson, A. B. Grudinin and D. C. Hanna, “Efficient cladding-pumped Tm-doped silica fibre laser with high power single-mode output at 2 μm,” Electron. Lett., vol.36, (2000), 711-712.

[4] V. Dominic, S. MacCormack, R. Waarts, S. Sanders, S. Bicknese, R. Dohle, E,. Wolak, P. S. Yeh and E. Zucker, “110W fibre laser,” Electron. Lett., vol.35, (1999), p.1158-1160.

[5] C. C. Cook and T. Y. Fan, “Spectral beam combining of Yb-doped fiber lasers in an external cavity,” in Trends in Optics and Photonics, vol.26, (Optical Society of America, Washington, D.C.), (1999), p.163-166.

[6] V. Daneu, A. Sanchez, T. Y. Fan, H. K. Choi, G. W. Turner and C. C. Cook, “Spectral beam combining of a broad-stripe diode laser array in an external cavity”, Opt. Lett., vol. 25, (2000), p. 405-407.

[7] EP-A-1 059 707

1. A source of optical radiation comprising:
a laser diode stack comprising one or more laser diode bars and operable to emit pump radiation;
beam shaping optics operable to focus the pump radiation into a beam with elongate cross-section;
an optical fibre having an inner cladding of elongate cross-section and arranged so that the beam of pump light is coupled into at least one of its ends; and
one or more optical fibre cores doped with active ions and having an overall elongate cross-section arranged parallel to the elongate cross-section of the inner cladding, and arranged to absorb the pump radiation via the inner cladding so as to generate and emit output radiation by stimulated emission.

2. A source of optical radiation according to claim 1, in which the stimulated emission produces laser action, the optical fibre core or cores being arranged within an optical cavity operable to provide optical feedback of the output radiation.

3. A source of optical radiation according to claim 1, in which the stimulated emission produces optical amplification, the optical fibre core or cores being arranged to receive signal radiation to be amplified by gain arising from absorption of the pump radiation.

4. A source of optical radiation according to any one of claims 1 to 3, in which the one or more optical fibre cores are positioned within the inner cladding of the optical fibre.

5. A source of optical radiation according to claim 4, and further comprising one or more additional optical fibres arranged side-by-side with the first-mentioned optical fibre such that pump light is additionally coupled into inner cladding of the additional fibre or fibres.

6. A source of optical radiation according to any one of claims 1 to 3, in which the one or more optical fibre cores are positioned within an inner cladding of a second optical fibre arranged in optical communication with the inner cladding of the first-mentioned optical fibre.

7. A source of optical radiation according to claim 6, and further comprising one or more additional laser diode stacks with associated beam shaping optics and optical fibres, each optical fibre having an inner cladding arranged in optical communication with the inner cladding of the second optical fibre.

8. A source of optical radiation according to any one of claims 1 to 7, in which the one or more optical fibre cores comprises a plurality of cores arranged in a linear array.

9. A source of optical radiation according to claim 8, in which the plurality of cores are substantially equally spaced along the linear array.

10. A source of optical radiation according to claim 8, in which the plurality of cores are unequally spaced along the linear array.

11. A source of optical radiation according to any one of claims 8 to 10, in which each of the plurality of cores is configured to emit output radiation in a beam having a single spatial mode.

12. A source of optical radiation according to any one of claims 8 to 11, and further comprising a beam combiner operable to combine the output radiation emitted by each of the plurality of cores into a single output beam.

13. A source of optical radiation according to claim 12, in which each of the plurality of cores operates at a different wavelength and the beam combiner comprises a collimating lens and a diffraction grating arranged such that the output of each core is diffracted by a common angle to form a single output beam.

14. A source of optical radiation according to any one of claims 1 to 7, in which the one or more optical fibre cores comprises a single core having an elongate cross-section.

15. A source of optical radiation according to any preceding claim, in which the optical fibre has an elongate cross-section with long sides which are substantially flat.

16. A source of optical radiation according to claim 15, in which the optical fibre core or cores is/are positioned asymmetrically with respect to the long sides of the fibre so as to facilitate removal of heat arising from absorption of the pump radiation.

17. A source of optical radiation according to any preceding claim, in which the active ions in the optical fibre core or cores comprise at least one of: neodymium, ytterbium, erbium, thulium, or other rare earth elements.

18. A source of optical radiation according to any preceding claim, in which the beam shaping optics comprises a light concentrator operable receive the pump radiation from the laser diode stack and reflect the pump radiation multiple times to produce a beam of reduced dimensions.

19. A source of optical radiation according to claim 18, in which the multiple reflections are achieved by the use of one or more mirrored surfaces.

20. A source of optical radiation according to claim 18, in which the multiple reflections are achieved by internal reflections within a prism.

21. A source of optical radiation according to any one of claims 18 to 20, in which the beam shaping optics further comprises a cylindrical lens located in front of the light concentrator and operable to focus the pump radiation as to reduce the amount of multiple reflections.

22. A source of optical radiation according to any one of claims 18 to 21, in which the light concentrator is configured such that the beam of pump radiation is produced with beam divergence angles which are substantially equal in all directions.

23. An optical system comprising two or more sources of optical radiation according to any preceding claim, and arranged so that the inner claddings in which the optical fibre cores are positioned are located side-by-side where the output radiation is emitted.

24. A method of generating optical radiation comprising:
generating pump radiation from a laser diode stack comprising one or more laser diode bars;
focusing the pump radiation into a beam with elongate cross-section; and
coupling the pump radiation into at least one end of an optical fibre having an inner cladding of elongate cross-section so that the pump radiation passes through the inner cladding and is absorbed by one or more optical fibre cores doped with active ions and having an overall elongate cross-section arranged parallel to the elongate cross-section of the inner cladding, so as to generate and emit output radiation by stimulated emission.
